(19) United States
(12) Patent Application Publication
(10) Pub. No.: US 2025/0323404 A1
(43) Pub. Date: Oct. 16, 2025

(54) Terminator of A Connector Assembly

(71) Applicant: TE Connectivity Solutions GmbH, Schaffhausen (CH)

(72) Inventors: Kevin McKee, Fremont, CA (US); Rohan Narang, Winston Salem, NC (US); Dhavalsinh Barad, Winston Salem, NC (US)

(73) Assignee: TE Connectivity Solutions GmbH, Schaffhausen (CH)

(21) Appl. No.: 18/631,270

(22) Filed: Apr. 10, 2024

(51) Int. Cl. H01P 1/24; H01R 13/52; H01R 13/627

(52) U.S. Cl. CPC H01P 1/24; H01R 13/5219; H01R 13/6273

(57) ABSTRACT

A terminator includes a terminator housing having a body and a pair of legs extending from the body, a pair of terminals each having a connection end and a termination end opposite the connection end, and a connection component positioned within the body and electrically connecting the termination ends of the terminals. Each of the terminals is positioned in one of the legs with the connection end protruding from the one of the legs. Each of the legs has a retention shoulder by which the terminator is latched.

### FIELD OF THE INVENTION

The present invention relates to a terminator and, more particularly, to a terminator for a connector.

### BACKGROUND

Some connectors, for example connectors forming a communication network such as a controller area network (CAN) bus, require termination. In the CAN communication system, terminating the connectors at the endpoints of the bus reduces signal reflection. Communication connectors are generally terminated by a dedicated termination connector; wiring from the communication connector is connected by a separate branch to a harness and the termination connector is connectable with the harness.

The termination connectors are unique to each application, limiting flexibility of the termination and requiring increased manufacturing costs. The connection of the communication connector with the termination connector also requires significant additional wiring and parts, further increasing manufacturing costs and the difficulty of assembly.

### SUMMARY

A terminator includes a terminator housing having a body and a pair of legs extending from the body, a pair of terminals each having a connection end and a termination end opposite the connection end, and a connection component positioned within the body and electrically connecting the termination ends of the terminals. Each of the terminals is positioned in one of the legs with the connection end protruding from the one of the legs. Each of the legs has a retention shoulder by which the terminator is latched.

### BRIEF DESCRIPTION OF THE DRAWINGS

The invention will now be described by way of example with reference to the accompanying Figures, of which:

FIG. 1 is a perspective view of a connector assembly according to an embodiment;

FIG. 2 is a perspective view of a terminator of the connector assembly;

FIG. 3 is a sectional plan view of the terminator;

FIG. 4 is a perspective view of a terminator according to another embodiment;

FIG. 5A is a perspective view of a pair of terminals and a connection component according to an embodiment;

FIG. 5B is a perspective view of a pair of terminals and a connection component according to another embodiment;

FIG. 6A is a detail perspective view of a connection component according to an embodiment in a body of a housing;

FIG. 6B is a detail perspective view of a connection component according to another embodiment in the body of the housing;

FIG. 7 is a front view of a connector assembly having a terminator housing with an asymmetrical shape according to an embodiment;

FIG. 8 is a sectional side view of the connector assembly of FIG. 1;

FIG. 9 is a perspective view of a terminator according to another embodiment;

FIG. 10 is a perspective view of the terminator of FIG. 9 without an outer housing; and

FIG. 11 is a perspective view of a terminator according to another embodiment without the outer housing.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Throughout the specification, directional descriptors are used such as “longitudinal direction” and “width direction”. These descriptors are merely for clarity of the description and for differentiation of the various directions. These directional descriptors do not imply or require any particular orientation of the disclosed elements.

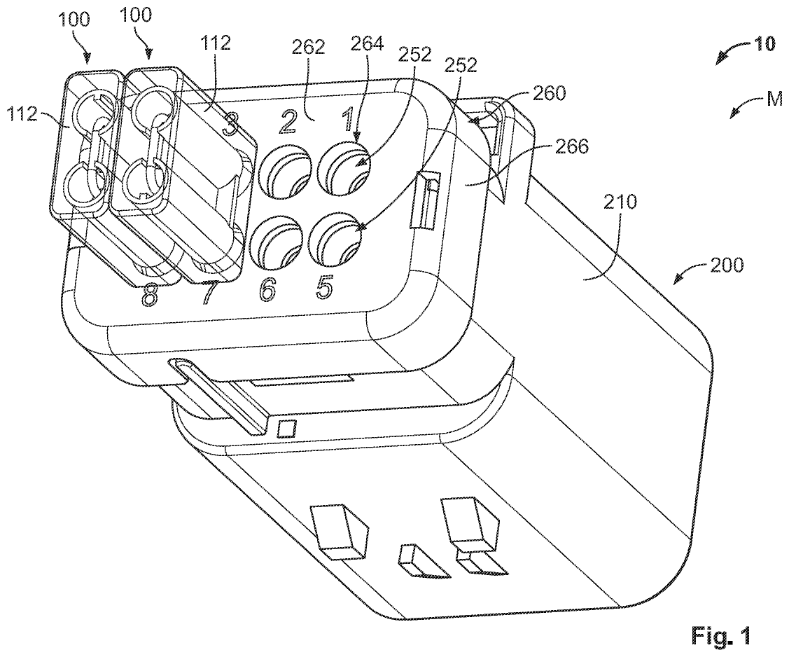

A connector assembly 10 according to an embodiment, as shown in FIG. 1, has a connector 200 and at least one terminator 100 inserted into the connector 200.

In an embodiment, the connector 200 is a connector of a controller area network (CAN) bus that forms an endpoint of the CAN communication system. The terminator 100 is inserted into the connector 200 to terminate the CAN communication system and reduce signal reflection. The terminator 100 and connector 200, however, are not limited to a CAN bus embodiment, as will be described below.

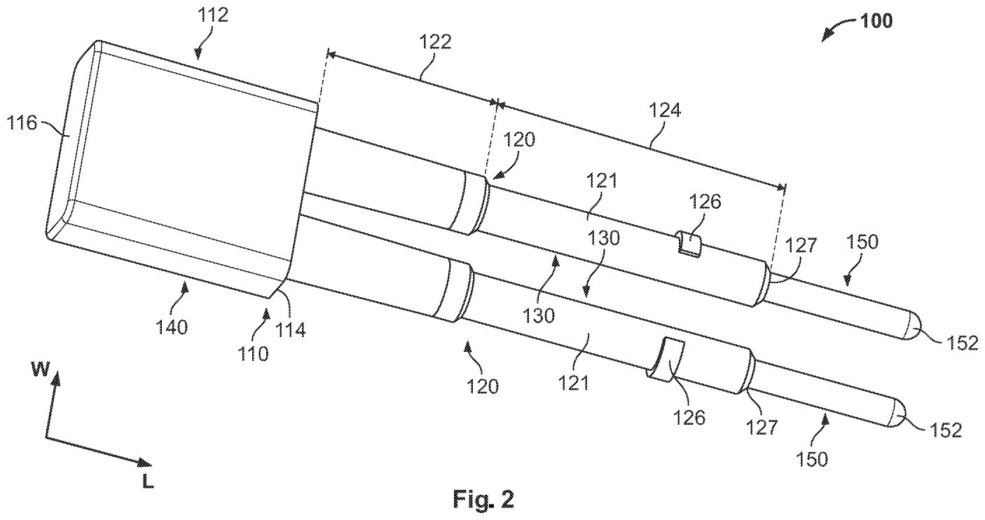

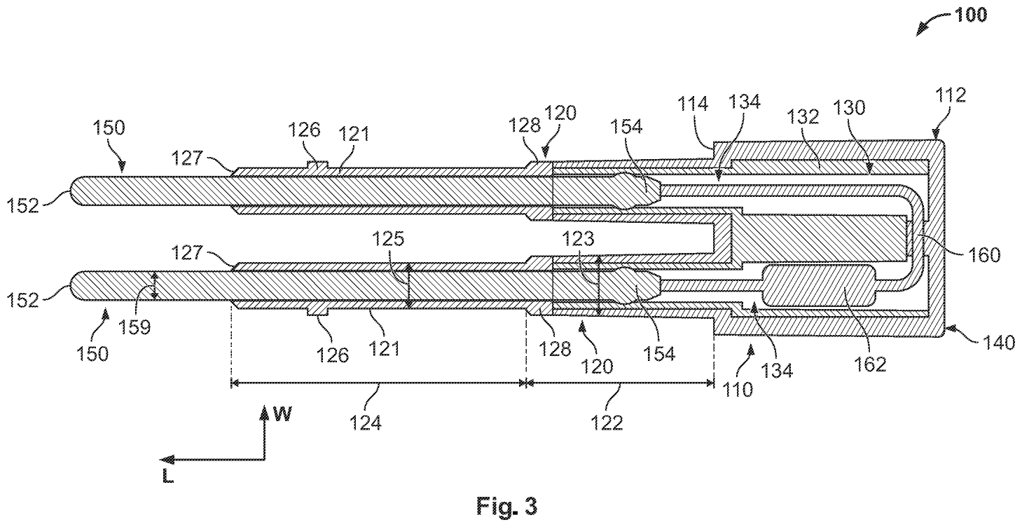

The terminator 100, as shown in FIGS. 2 and 3, has a terminator housing 110, a pair of terminals 150 disposed in the terminator housing 110, and a connection component 160 disposed in the terminator housing 110 and connecting the terminals 150.

As shown in FIGS. 2 and 3, the terminator housing 110 has a body 112 and a pair of legs 120 extending from a mating face 114 of the body 112. In the shown embodiment, the body 112 is an approximately rectangular element and the legs 120 are each cylindrical. The legs 120 extend along a longitudinal direction L from the body 112 and are spaced apart from each other in a width direction W perpendicular to the longitudinal direction L.

The legs 120, as shown in FIGS. 2 and 3, each have a first section 122 extending from the body 112 and a second section 124 extending from the first section 122 along the longitudinal direction L. The second sections 124 extend from the first section 122 to an end 127 of each of the legs 120 opposite the body 112. The first section 122 has a first leg diameter 123 and the second section 124 has a second leg diameter 125. In the shown embodiment, the first leg diameter 123 is greater than the second leg diameter 125.

Each of the legs 120 has an outer surface 121 and a retention shoulder 126 protruding from the outer surface 121, as shown in FIGS. 2 and 3. In the shown embodiment, the retention shoulder 126 has a semicircular shape extending circumferentially around a portion of the leg 120. The retention shoulder 126 extends, in the example shown in FIGS. 2 and 3, approximately halfway around the circumference of the leg 120 on a side of the leg 120 opposite the other of the legs 120 in the width direction W. In other embodiments, the retention shoulder 126 can extend around a greater portion of the leg 120, including completely circumferentially around the leg 120.

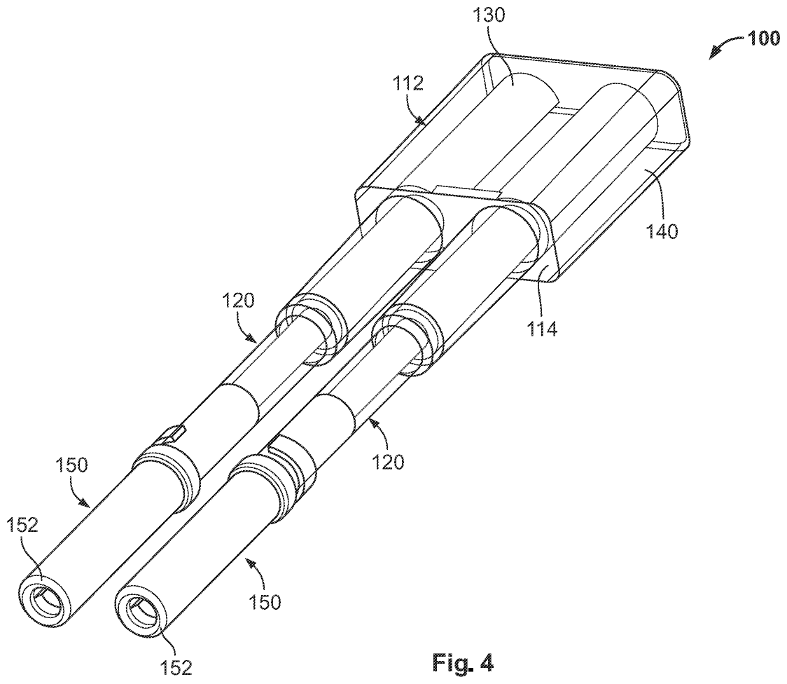

Each of the terminals 150, as shown in FIG. 3, has a connection end 152 and a termination end 154 opposite the connection end 152 in the longitudinal direction L. The terminals 150 may be formed of any type of conductive material, such as copper or aluminum, that is commonly used in electrical connections. In the embodiment shown in FIGS. 2 and 3, the terminal 150 is a pin terminal and the connection end 152 is formed as a pin. In other embodiments, as shown in FIG. 4, the terminal 150 may be a socket terminal having the connection end 152 formed as a socket capable of receiving a pin. Each of the terminals 150 has a terminal diameter 159 that is less than the first leg diameter 123 and the second leg diameter 125.

As shown in FIG. 3, the connection component 160 is positioned within the body 112 of the terminator housing 110. The connection component 160 is formed of a conductive material, such as aluminum or copper, and electrically connects the termination ends 154 of the terminals 150. In the embodiment shown in FIG. 3, the connection component 160 has a resistor 162, for example a 120 Ohm resistor, positioned within the body 112 and connected between the termination ends 154 of the terminals 150.

The assembly of the terminator 100 will now be described in greater detail.

In the embodiment shown in FIGS. 2 and 3, the terminator housing 110 is formed of an inner housing 130 and an outer housing 140. The inner housing 130 is molded or otherwise formed of an insulative material. The inner housing 130 has an inner base 132, shown in FIG. 3, and forms the second section 124 of the legs 120 extending from the inner base 132, with a stop 128 protruding from the outer surface 121 of the legs 120. The inner housing 130 has a pair of housing passageways 134 extending in the longitudinal direction L from the inner base 132 through the legs 120.

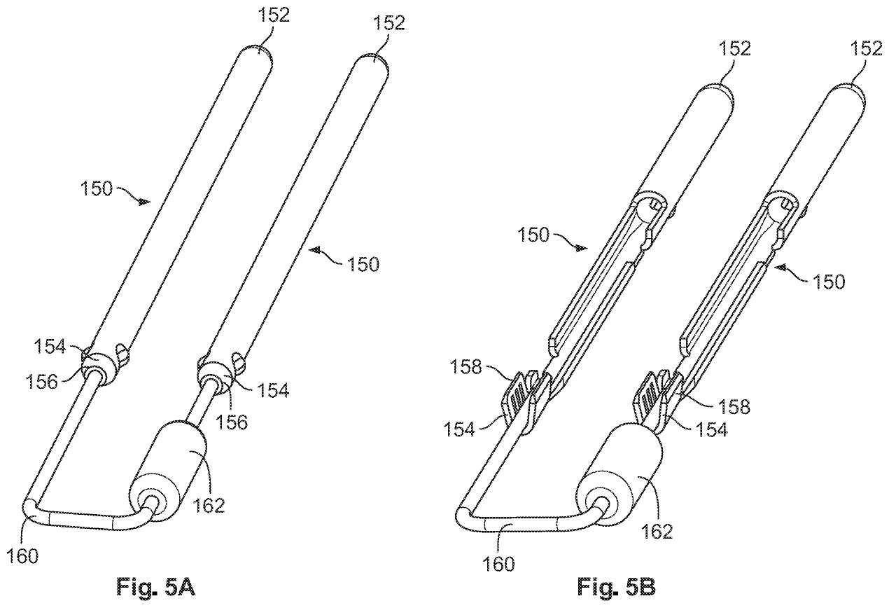

The terminals 150 are connected to the connection component 160, as shown in FIGS. 5A and 5B, before being inserted into the inner housing 130. In the embodiment shown in FIG. 5A, the termination ends 154 of the terminals 150 each receive one of the ends of the connection component 160 and are welded to the connection component 160 at a weld 156, for example by laser welding. In another embodiment shown in FIG. 5B, the termination ends 154 of the terminals 150 each have a crimping section 158 with a pair of crimp wings that are crimped to the connection component 160. In another embodiment, the connection component 160 could be soldered to the termination ends 154.

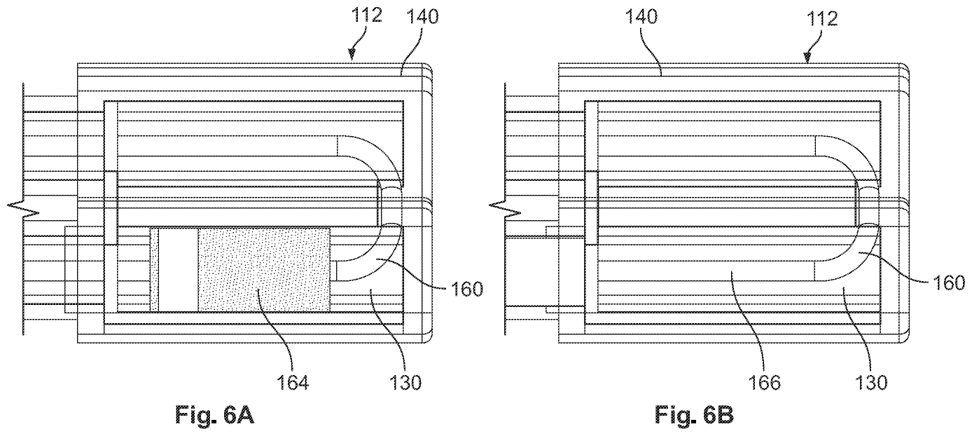

In the embodiment shown in FIGS. 3, 5A, and 5B, the connection component 160 has the resistor 162 described above connected between the terminals 150. The resistor 162 may be part of the connection component 160, for example, when the terminator 100 is used in the CAN bus embodiment described above. In other embodiments, as shown in FIGS. 6A and 6B, the connection component 160 may include other electrical components or no additional electrical components connected between the terminals 150. In the embodiment shown in FIG. 6A, the connection component 160 has a diode 164 connected between the terminals 150. In the embodiment shown in FIG. 6B, the connection component 160 is formed as a bus 166 connected between the terminals 150 with no additional electrical component.

The terminals 150 connected to the connection component 160 are inserted into the inner housing 130. As shown in FIG. 3, each of the terminals 150 is positioned in one of the legs 120 and extends through one of the housing passageways 134. When fully inserted, the connection end 152 of each of the terminals 150 protrudes from the one of the legs 120 along the longitudinal direction L. The connection component 160 is inserted into the inner housing 130 with the terminals 150 and is positioned in the housing passageways 134 in the inner base 132.

In the embodiment shown in FIGS. 2 and 3, the outer housing 140 is an insulative material molded around the inner housing 130 with the terminals 150 and the connection component 160 positioned in the inner housing 130. The outer housing 140 covers the inner base 132 of the inner housing 130 and covers a portion of each of the legs 120 up to the stop 128. The outer housing 140 forms the first section 122 of the legs 120 having the first leg diameter 123.

The outer housing 140 molded around the inner housing 130 forms the terminator housing 110 enclosing the connection component 160 and a portion of the terminals 150 in the body 112. In FIGS. 1, 3, 4, 6A, 6B, and 7, the outer housing 140 is shown transparent only for clarity of the details in the positioning of the inner housing 130, the terminals 150, and the connection component 160. In application, the outer housing 140 may be opaque as shown in FIG. 2 or may alternatively be transparent or translucent.

In other embodiments, the terminator housing 110 can be formed other than by inserting the terminals 150 and the connection component 160 into the inner housing 130 and molding the outer housing 140 around the inner housing 130. In an embodiment, the terminator housing 110, including all the elements of the inner housing 130 and the outer housing 140 described above, can be formed entirely by overmolding around the terminals 150 and the connection component 160. In another embodiment, the inner housing 130 and the outer housing 140 can be formed as one piece without a rear surface 116 of the body 112, shown in FIG. 2, and the terminals 150 and the connection component 160 can be inserted into the integrally formed inner housing 130 and outer housing 140; in this embodiment, the rear surface 116 is a separate piece that is plastic welded or otherwise sealingly attached to the body 112 to enclose the terminals 150 and the connection component 160.

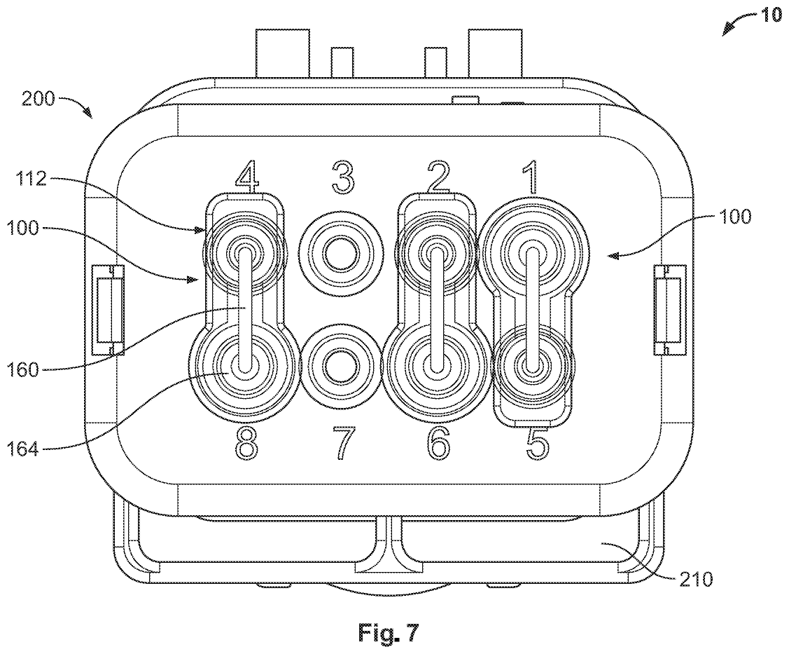

In the embodiment shown in FIGS. 2-4, the body 112 of the terminator housing 110 has a symmetric rectangular shape. In other embodiments, for example in embodiments in which the connection component 160 has the diode 164, the body 112 of the terminator housing 110 may have an asymmetric shape as shown in FIG. 7. The asymmetric shape accommodates the size of the diode 164, which is generally larger than the resistor 162, and provides a polarity indicating a position of the diode 164 in the body 112.

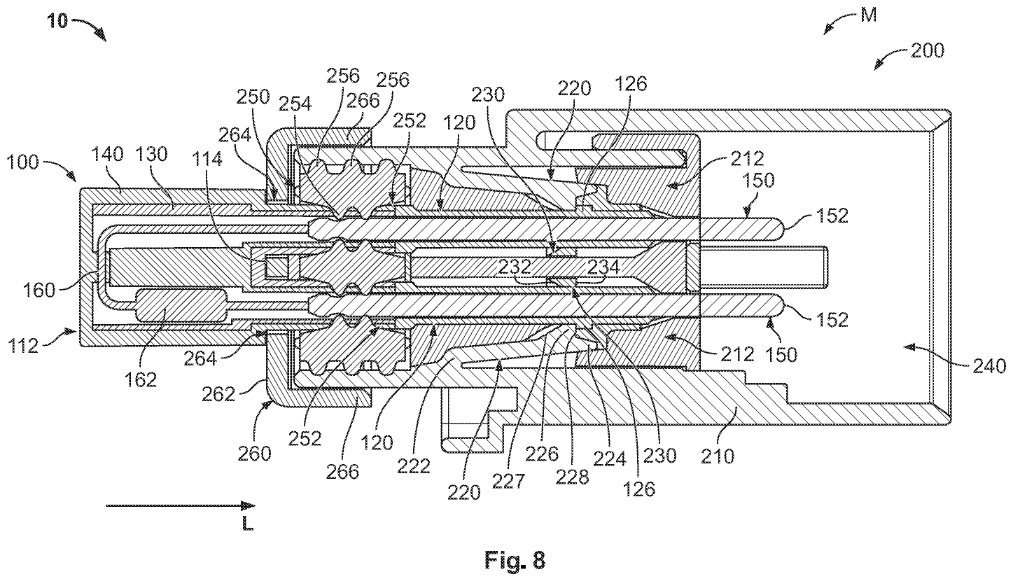

The connector 200, as shown in FIG. 8, has a connector housing 210 with a plurality of terminal receiving passageways 212 extending through the connector housing 210 in the longitudinal direction L. The connector housing 210 has an interior receiving space 240 communicating with the terminal receiving passageways 212.

Each of the terminal receiving passageways 212 has a latch arm 220 on a side of the terminal receiving passageway 212. The latch arm 220 is cantilevered in the shown embodiment and extends from a fixed end 222 connected to the connector housing 210 to a free end 224 that is opposite the fixed end 222. The latch arm 220 is resiliently deflectable about the fixed end 222.

As shown in FIG. 8, the latch arm 220 has a latch protrusion 226 extending from the latch arm 220 between the fixed end 222 and the free end 224. The latch protrusion 226 protrudes from the latch arm 220 into the terminal receiving passageway 212. The latch protrusion 226 has a first latch side 227 and a second latch side 228 opposite the first latch side 227 in the longitudinal direction L. The first latch side 227 is sloped with respect to the longitudinal direction L and the second latch side 228 extends approximately perpendicular to the longitudinal direction L.

In the embodiment shown in FIG. 8, each of the terminal receiving passageways 212 has a retention protrusion 230 opposite the latch arm 220. The retention protrusion 230 is fixed to the connector housing 210 and has a first retention side 232 and a second retention side 234 opposite the first retention side 232. The first retention side 232 is sloped with respect to the longitudinal direction L and the second retention side 234 extends approximately perpendicular to the longitudinal direction L.

As shown in FIG. 8, the connector 200 has a seal 250 positioned within the connector housing 210. The seal 250 is formed of an elastomeric material and has a plurality of seal passageways 252 extending through the seal 250 along the longitudinal direction L. The seal 250 has a plurality of inner ribs 254 extending into each of the seal passageways 252 and a plurality of outer ribs 256 extending from an outer surface of the seal 250. The seal 250 is positioned in the connector housing 210 with each of the seal passageways 252 aligned with one of the terminal receiving passageways 212. In the shown embodiment, the seal 250 is integrally formed in a single piece with the plurality of seal passageways 252. In other embodiments, the seal 250 could be formed of a plurality of separate pieces positioned in alignment with the terminal receiving passageways 212 as described herein.

In the embodiment shown in FIG. 8, the connector 200 has a cap 260 that is positioned on an end of the connector housing 210 and retains the seal 250 in the connector housing 210. The cap 260 has a connector mating face 262 with a plurality of openings 264 extending through the connector mating face 262 and a plurality of side walls 266 extending from the connector mating face 262. The side walls 266 are attached around the connector housing 210 and the connector mating face 262 retains the seal 250 in the connector housing 210, with each of the openings 264 aligned with one of the seal passageways 252 along the longitudinal direction L. In other embodiments, the cap 260 can be omitted and the seal 250 can be retained in the connector housing 210 by a friction fit.

The insertion of the terminator 100 into the connector 200 to form the connector assembly 10 will now be described in greater detail primarily with reference to FIGS. 1 and 8. As shown in the embodiment of FIG. 1, the connector 200 may have a plurality of terminal receiving passageways 212 each corresponding to one seal passageway 252 and one opening 264 in the cap 260. Each terminator 100 is inserted into two of the terminal receiving passageways 212 to terminate a portion of the connector 200.

As shown in FIG. 8, each of the legs 120 of the terminator 100 is inserted through one of the openings 264 of the cap 260, through one of the seal passageways 252 of the seal 250, and into one of the terminal receiving passageways 212 of the connector housing 210. As each of the legs 120 enters the terminal receiving passageway 212, the retention shoulder 126 first contacts the first latch side 227 of the latch protrusion 226 and slides along the first latch side 227, deflecting the latch arm 220 out of the terminal receiving passageway 212. When the retention shoulder 126 reaches the second latch side 228 of the latch protrusion 226, the latch arm 220 elastically returns and engages behind the retention shoulder 126 in the longitudinal direction L in a mated position M of the terminator 100 with the connector 200, as shown in FIG. 8.

The latch arm 220 latches to the terminator 100 in the mated position M to retain the terminator 100 in the connector 200. In the mated position M, as shown in FIG. 8, the connection ends 152 of the terminals 150 extend into the interior receiving space 240 of the connector housing 210 and are exposed for connecting to other electrical elements.

During insertion of the legs 120 into the terminal receiving passageways 212, the semicircular shape of the retention shoulder 126 engages the latch arm 220 as described above while bypassing the retention protrusion 230 to move into engagement with the latch arm 220. The retention protrusion 230 does not engage the leg 120 or aid in securing the terminator 100 in the shown embodiment. By bypassing the retention protrusion 230, both legs 120 of the terminator 100 can be simultaneously inserted into the two terminal receiving passageways 212 to the mated position M; bypassing the retention protrusions 230 allows the legs 120 to move straight along the longitudinal direction L to the mated position M without significant deflection of the legs 120, which would complicate insertion for the two rigid legs 120 that extend from the body 112 of the terminator 100. In another embodiment, however, the retention shoulder 126 can extend fully around each of the legs 120, requiring deflection of the legs 120 to pass the retention protrusion 230 and forming a more difficult to reverse engagement between the terminator 100 and the connector 200 in the mated position M.

In the mated position M, as shown in FIG. 8, the first section 122 of each of the legs 120 is positioned in one of the seal passageways 252 of the seal 250. The first leg diameter 123 of the first section 122 is sufficiently large for the inner ribs 254 of the seal 250 to deflect and sealingly engage to the first section 122 of the leg 120. The outer ribs 256 of the seal 250 form a seal with the connector housing 210. The seal 250 forms a seal between the connector 200 and the terminator 100 in the mated position M.

In the mated position M, the body 112 of the terminator 100 is positioned outside of the connector 200, as shown in FIGS. 1 and 8. The body mating face 114 of the body 112 abuts the connector mating face 262 of the cap 260 in the mated position M.

In the embodiment shown in FIG. 1, the symmetrical bodies 112 of the terminator housings 110 allow the terminators 100 to be positioned next to one another to terminate various positions of the connector 200. As shown in the embodiment of FIG. 7, the asymmetrically formed bodies 112 allow the terminators 100 to be positioned adjacent to one another while indicating the position of the diode 164 in the body 112, as described above. In various embodiments, the terminators 100 can be used to terminate all the positions of the connector 200 or can leave open positions for other connections to the connector 200, such as wire-to-wire connections.

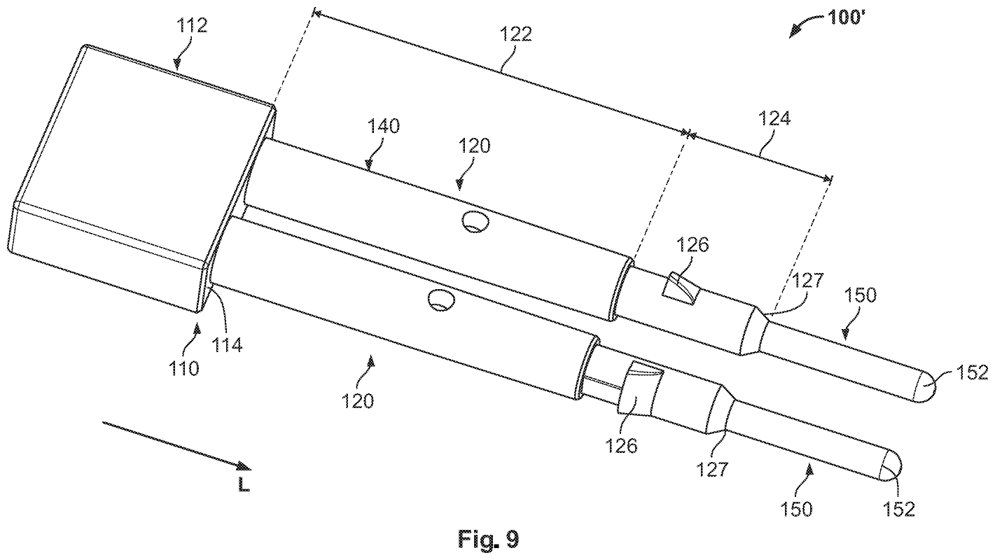

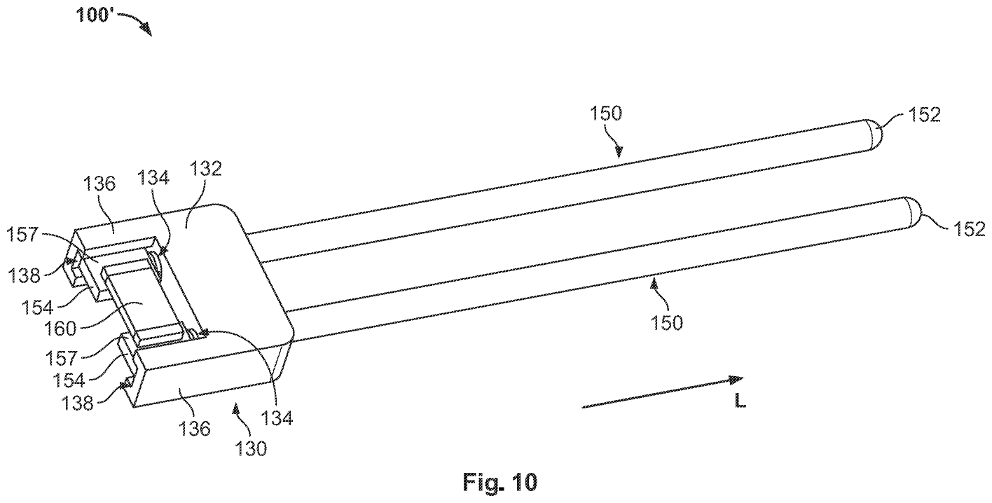

A terminator 100′ according to another embodiment is shown in FIGS. 9 and 10. Like reference numbers refer to like elements and primarily the differences with respect to the terminator 100 shown in the embodiment of FIGS. 1-8 will be described in detail herein.

The terminator housing 110 of the terminator 100′, as shown in FIGS. 9 and 10, includes the outer housing 140 disposed around the inner housing 130. In this embodiment, the outer housing 140 forms the body 112 and an entirety of each of the legs 120; the outer housing 140 forms the legs 120 in the first section 122 extending from the body 112 and in the second section 124 extending from the first section 122 along the longitudinal direction L. The outer housing 140 forms the retention shoulders 126 in the second sections 124.

The inner housing 130 of the terminator 100′, as shown in FIG. 10, has housing passageways 134 extending through the inner base 132 along the longitudinal direction L. The inner base 132 in the embodiment of FIG. 10 has a pair of base sides 136 extending along the longitudinal direction L. Each of the base sides 136 has a U-shaped channel 138 formed in the base side 136.

As shown in FIG. 10, in the terminator 100′, the termination end 154 of each of the terminals 150 is formed as a flat surface 157.

To assemble the terminator 100′, the terminals 150 are each inserted into the inner housing 130 through one of the housing passageways 134. The termination ends 154 of the terminals 150, with the flat surfaces 157, fit into the U-shaped channels 138 in the base sides 136, as shown in FIG. 10. The U-shaped channels 138 secure the termination ends 154 of the terminals 150 while exposing a portion of each of the flat surfaces 157.

The connection component 160 is then connected to the termination ends 154 of the terminals 150. As shown in the embodiment of FIG. 10, the connection component 160, which may be a diode, a resistor, a bus, or any other electronic component as described above, is capable of being surface mounted. The connection component 160 is surface mounted to the flat surfaces 157 at the termination ends 154 of the terminals 150 to form a mechanical and electrical connection between the connection component 160 and the terminals 150.

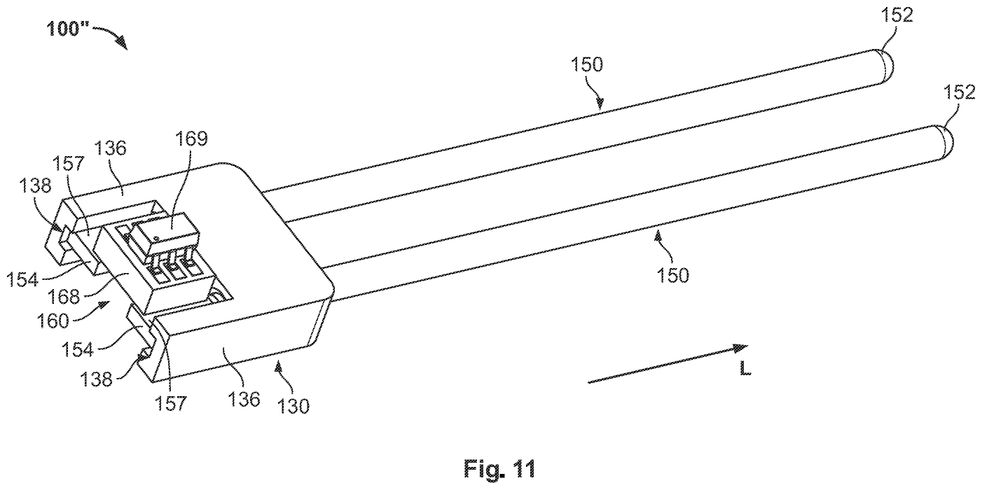

In a terminator 100″ according to another embodiment shown in FIG. 11, the connection component 160 is a programmable component that is capable of being surface mounted to the flat surfaces 157. In this embodiment, the connection component 160 has a printed circuit board (PCB) 168 and a controller 169 mounted on the PCB 168. The PCB 168 is surface mounted to the flat surfaces 157 at the termination ends 154 of the terminals 150 to form a mechanical and electrical connection between the connection component 160 and the terminals 150. The controller 169 mounted on the PCB 168 is programmable to perform a number of different functions, including acting as a programmable resistor or diode, in forming the connection between the terminals 150.

In the embodiments of the terminator 100′, 100″ shown in FIGS. 9-11, the outer housing 140 is overmolded around the inner housing 130, the terminals 150 and the connection component 160. The outer housing 140 forms the base 112 and the legs 120 as described above and shown in FIG. 9. The terminator 100′, 100″ can be used with the connector 200 as shown in FIG. 8 and described herein.

The terminators 100, 100′, 100″ according to the embodiments described above are pluggable directly into the connector 200 without intervening wiring or other elements. The terminators 100, 100′, 100″ can be interchangeably used in connectors 200 having a number of different positions in a number of different arrangements, as the legs 120 are pluggable into two adjacent positions in different orientations. The latching of the terminator 100, 100′, 100″ to the connector 200 secures the terminator 100, 100′, 100″ while still permitting both legs 120 to be simultaneously inserted for ease of assembly. The terminators 100, 100′, 100″ seal to the connectors 200 while requiring fewer parts for the termination and offering increased flexibility and ease of use.

What is claimed is:

1. A terminator, comprising:
a terminator housing having a body and a pair of legs extending from the body, each of the legs has a retention shoulder by which the terminator is latched;
a pair of terminals each having a connection end and a termination end opposite the connection end, each of the terminals is positioned in one of the legs with the connection end protruding from the one of the legs; and
a connection component positioned within the body and electrically connecting the termination ends of the terminals.

2. The terminator of claim 1, wherein the retention shoulder has a semicircular shape extending circumferentially around a portion of each of the legs.

3. The terminator of claim 1, wherein each of the legs has a first section extending from the body and a second section extending from the first section to an end of the leg opposite the body, the first section has a first leg diameter that is greater than a second leg diameter of the second section.

4. The terminator of claim 3, wherein the terminator housing includes an inner housing and an outer housing, the outer housing forms the first section of the legs.

5. The terminator of claim 4, wherein the terminals and the connector component are inserted into the inner housing that forms the second section of the legs.

6. The terminator of claim 4, wherein the outer housing forms the second section of the legs.

7. The terminator of claim 1, wherein the termination ends of the terminals are each welded to the connection component or are each crimped to the connection component.

8. The terminator of claim 1, wherein the connection component has a resistor connected between the terminals and positioned within the body.

9. The terminator of claim 1, wherein the connection component has a diode or a bus connected between the terminals and positioned within the body.

10. The terminator of claim 1, wherein the connection component is surface mounted to the termination ends of the terminals.

11. The terminator of claim 10, wherein the connection component includes a printed circuit board and a controller mounted on the printed circuit board.

12. The terminator of claim 1, wherein the body of the terminator housing has an asymmetric shape.

13. A connector assembly, comprising:
a connector having a connector housing with a plurality of terminal receiving passageways each having a latch arm; and
a terminator including a terminator housing having a body and a pair of legs extending from the body, a pair of terminals each having a connection end and a termination end opposite the connection end, each of the terminals is positioned in one of the legs with the connection end protruding from the one of the legs, and a connection component positioned within the body and electrically connecting the termination ends of the terminals, the legs are each inserted into one of the terminal receiving passageways, each of the legs has a retention shoulder engaged by the latch arm of one of the terminal receiving passageways.

14. The connector assembly of claim 13, wherein the retention shoulder has a semicircular shape extending circumferentially around a portion of each of the legs.

15. The connector assembly of claim 14, wherein each of the terminal receiving passageways has a retention protrusion opposite the latch arm, the semicircular shape of the retention shoulder bypasses the retention protrusion to move into engagement with the latch arm.

16. The connector assembly of claim 13, wherein the connector has a seal with a plurality of seal passageways, each of the seal passageways is aligned with one of the terminal receiving passageways.

17. The connector assembly of claim 16, wherein each of the legs is positioned in one of the seal passageways and is in sealing engagement with the seal in the one of the seal passageways.

18. The connector assembly of claim 17, wherein each of the legs has a first section extending from the body and a second section extending from the first section to an end of the leg opposite the body, the first section has a first leg diameter that is greater than a second leg diameter of the second section, the seal engages the first section in a mated position in which the latch arm engages the retention shoulder.

19. The connector assembly of claim 13, wherein the legs are simultaneously insertable into the terminal receiving passageways.

20. The connector assembly of claim 13, wherein the legs extend from a body mating face of the body, the body is positioned outside of the connector and the body mating face abuts a connector mating face of the connector in a mated position in which the latch arm engages the retention shoulder.
